(19) United States
(12) Patent Application Publication
(10) Pub. No.: US 2008/0029375 A1
(43) Pub. Date: Feb. 7, 2008

(54) Key button

(75) Inventor: Karl-Heinz Muller, Auerbach/Opf. (DE)

Correspondence Address: Raymond R. Ferrera, 1221 McKinney Street, Suite 4400, Houston, TX, 77010, US

(73) Assignee: Cherry GmbH

(21) Appl. No.: 11/888,384

(22) Filed: Aug. 1, 2007

(30) Foreign Application Priority Data
Aug. 1, 2006 (DE) 20 2006 011 803.9

(51) Int. Cl. H01H 13/14

(52) U.S. Cl. 200/341

(57) ABSTRACT

A key button comprising an inscription surface, a base part and a cap part which can be releasably placed onto the base part, characterized in that the inscription surface is divided into a first partial surface for an interchangeable inscription and a second partial surface for a permanent inscription, wherein a surface of the cap part covers the first partial surface when the cap part is placed onto the base part.

The invention relates to a key button.

In many software applications, the possibility exists of assigning functions of the software application to keys of an input device in order to make it easier for a user to control the software application. For the free assignment of functions, keyboards usually have so-called function keys which are arranged to the side of or above the actual key array. The key buttons of these function keys are usually inscribed with the letter F followed by one numeral or two numerals. This inscription does not help a user to find a key with an individually stored function. Key buttons have therefore been developed which the user can inscribe with symbols of his choice.

In a software application, often one function is already pre-assigned to a function key and a further function which can be activated by simultaneously pressing a second key can additionally be assigned to the function key. The Help context of the software application for example will then refer to the pre-assigned function using the standard inscription of the function key (F and number). Moreover, it is not possible or necessary in all software applications to assign a function individually to a function key, so that in these cases too the inscription of the function key should correspond to the standard inscription. On the other hand, in software applications where it is possible to carry out an individual assignment of the function key, it should be possible for the inscription of the function key to be adapted by a user to the respective stored function. Prior art key buttons which can be inscribed by a user meet only this last-mentioned requirement.

The object of the present invention is therefore to provide a key button which helps a user to find a key, both when the key is individually assigned a function of a software application by the user and when the key is assigned a function by a software application and reference is made to the key using a predefined inscription.

This object is achieved by a key button according to the present invention.

A key button according to the invention comprises an inscription surface, a base part and a cap part which can be releasably placed onto the base part. The inscription surface is divided into a first partial surface for an interchangeable inscription and a second partial surface for a permanent inscription, wherein a surface of the cap part covers the first partial surface when the cap part is placed onto the base part.

The base part has an underside, an upper side, a front flank, a rear flank, a left side flank and a right side flank. Preferably one or more plungers are arranged on the underside for mounting a key button according to the invention on a key base body. The upper side is located opposite the underside and serves as an actuating surface of a key comprising a key button according to the invention. Of the four side surfaces of the base part, the front flank is the side surface of the base part which faces towards a user. The rear flank is the side surface of the base part which is located opposite the front flank and faces away from a user. The right side flank is the side surface of the base part which adjoins the front flank to the right. The left side flank is the side surface of the base part which adjoins the front flank to the left and is located opposite the right side flank.

The inscription surface preferably corresponds to the upper side of the base part, but may also be for example the front flank. The inscription surface is divided by a dividing line into the first partial surface and the second partial surface. The dividing line is preferably straight and perpendicular to a front edge which corresponds to the line where the front flank meets the upper side. However, the dividing line may also be curved and/or may form an angle other than a right angle with the front edge.

The second partial surface preferably has a permanent inscription which cannot be changed. The permanent inscription can be produced for example by means of a laser beam method on the second partial surface.

The first partial surface preferably has an interchangeable inscription. The inscription of the first partial surface can be interchanged in two ways, as will be explained further below.

The ratio of the size of the first partial surface to the size of the second partial surface is preferably 2 to 1, since the permanent inscription usually consists only of one letter and/or one number or two numbers and thus a larger surface is available for the interchangeable inscription. However, the ratio between the sizes of the partial surfaces may also be selected differently, so that for example the inscription surface is divided into two partial surfaces of equal size.

The cap part has an inner side and an outer side and can be placed onto the base part in a releasable manner. To this end, the inner side of the cap part is designed as a negative form of the base part so that, when the cap part is placed onto the base part, the inner side of the cap part bears approximately fully against the base part and the base part is partially covered by the cap part. In particular, the first partial surface of the inscription surface is covered by a surface of the cap part, whereas the second partial surface of the inscription surface is not covered by the cap part. One preferred embodiment of the cap part will be described further below.

When the cap part is placed onto the base part, the cap part is fixed to the base part in a releasable manner, preferably by means of elastic latching elements. For the purpose of releasable fixing, the cap part advantageously has snap-in hooks which hook into complementary cutouts on the base part and disengage again when a limit tensile stress is exceeded. Preferably, the snap-in hooks are arranged on several surfaces on the inner side of the cap part, as will be explained further below. A fixing of the cap part to the base part by means of snap-in hooks ensures a captive and immovable arrangement of the cap part while at the same time ensuring that the cap part can easily be removed from the base part. The cap part can be removed from the base part without the need for tools, as a result of which it is easier to change the interchangeable inscription.

In one preferred embodiment of a key button according to the invention, the surface of the cap part which covers the first partial surface bears an inscription. By replacing the cap part with a different cap part bearing a different inscription, the inscription of the first partial surface of the inscription surface can thus be interchanged in a first way.

In a further preferred embodiment of a key button according to the invention, the cap part is made from a transparent material such as polymethyl acrylate for example, so that the surfaces of the base part which are covered by the cap part are visible through the cap part.

In a further preferred embodiment of a key button according to the invention, the first partial surface of the inscription surface has a recess for accommodating an inscription carrier. The recess advantageously has a rectangular shape and preferably extends over almost the entire first partial surface of the inscription surface, so that only a narrow edge delimits the recess. The inscription carrier is advantageously made from paper or plastic and can be written on or printed on by a user. Alternatively, the inscription carrier may already be printed on by a manufacturer, such as for example a manufacturer of a software application. The thickness of the inscription carrier preferably lies within a range from the thickness of letter paper to a few millimetres. The edge of the recess serves for lateral guidance of the inscription carrier within the first partial surface of the inscription surface. Perpendicular to the first partial surface of the inscription surface, the inscription carrier is held in the recess by the cap part. In this embodiment, the cap part is made from a transparent material so that the inscription carrier is visible through the cap part. The length and width of the inscription carrier and the depth of the recess are preferably dimensioned in such a way that the upper side of the inscription carrier placed in the recess ends approximately flush with the edge of the recess. By replacing the inscription carrier with a different inscription carrier bearing a different inscription, the inscription of the first partial surface of the inscription surface can thus be interchanged in a second way. Furthermore, the recess may bear an inscription so that the inscription of the recess is visible when no inscription carrier is located in the recess.

In a further preferred embodiment, a key button according to the invention comprises a base part which has an upper side, a front flank, a rear flank, a first side flank and a second side flank, wherein the upper side, the front flank and the rear flank are in each case divided into a first partial surface which adjoins the first side flank and a second partial surface which adjoins the second side flank, and a cap part which has a cap upper side, a cap front flank, a cap rear flank and a cap side flank, wherein the cap side flank approximately completely covers the first side flank, the cap upper side approximately completely covers the first partial surface of the upper side, the cap front flank approximately completely covers the first partial surface of the front flank and the cap rear flank approximately completely covers the first partial surface of the rear flank.

When the cap part is placed onto the base part, the cap front flank is the side surface of the cap part which faces towards a user. The cap rear flank is the side surface of the cap part which is located opposite the cap front flank and faces away from a user.

The first side flank is a side surface of the base part and corresponds either to the left side flank of the base part or to the right side flank of the base part. The second side flank is the side surface of the base part which is located opposite the first side flank.

The cap side flank is the side surface of the cap part which, when the cap part is placed onto the base part, lies over the first side flank of the base part and approximately completely covers the first side flank of the base part.

The upper side of the base part is divided into a first partial surface and a second partial surface. A dividing plane between the first partial surface of the upper side and the second partial surface of the upper side is perpendicular to the upper side of the base part and preferably perpendicular to the front flank of the base part. The first partial surface of the upper side adjoins the first side flank and the second partial surface of the upper side adjoins the second side flank.

When the cap part is placed onto the base part, the cap upper side lies over the first partial surface of the upper side of the base part and the cap upper side approximately completely covers the first partial surface of the upper side of the base part. The second partial surface of the upper side of the base part and the cap upper side together form an actuating surface of a key comprising a key button according to the invention.

The front flank of the base part is divided into a first partial surface and a second partial surface. A dividing plane between the first partial surface of the front flank and the second partial surface of the front flank is preferably identical to the dividing plane between the first partial surface of the upper side and the second partial surface of the upper side. The first partial surface of the front flank adjoins the first side flank and the second partial surface of the front flank adjoins the second side flank.

When the cap part is placed onto the base part, the cap front flank lies over the first partial surface of the front flank of the base part and the cap front flank approximately completely covers the first partial surface of the front flank of the base part.

The rear flank of the base part is divided into a first partial surface and a second partial surface. A dividing plane between the first partial surface of the rear flank and the second partial surface of the rear flank is preferably identical to the dividing plane between the first partial surface of the upper side and the second partial surface of the upper side. The first partial surface of the rear flank adjoins the first side flank and the second partial surface of the rear flank adjoins the second side flank.

When the cap part is placed onto the base part, the cap rear flank lies over the first partial surface of the rear flank of the base part and the cap rear flank approximately completely covers the first partial surface of the rear flank of the base part.

In a further preferred embodiment of a key button according to the invention, the dimensions of the base part in the region delimited by the first side flank and also the first partial surface of the upper side, the first partial surface of the front flank and the first partial surface of the rear flank are reduced in such a way that, when the cap part is placed onto the base part, the second partial surface of the upper side of the base part ends approximately flush with the cap upper side, the second partial surface of the front flank of the base part ends approximately flush with the cap front flank and the second partial surface of the rear flank of the base part ends approximately flush with the cap rear flank. In this embodiment, the first partial surface of the upper side and the second partial surface of the upper side form a step at their common side. The step is preferably perpendicular to the first partial surface of the upper side. The same applies in respect of the first and second partial surface of the front flank and the first and second partial surface of the rear flank. The steps in the upper side, the front flank and the rear flank form a bearing surface for the side of the cap part located opposite the cap side flank. The bearing surface prevents displacement of the cap part in the direction of the second side flank of the base part.

In this embodiment, for the releasable fixing of the cap part to the base part, the cap part has a respective snap-in hook on the cap side flank, the cap front flank and the cap rear flank. In conjunction with the bearing surface, the snap-in hooks on the three flank sides of the cap part ensure a captive and immovable arrangement of the cap part while at the same time ensuring that the cap part can easily be removed from the base part.

The invention will be explained in more detail below with reference to the drawing.

In the drawing:

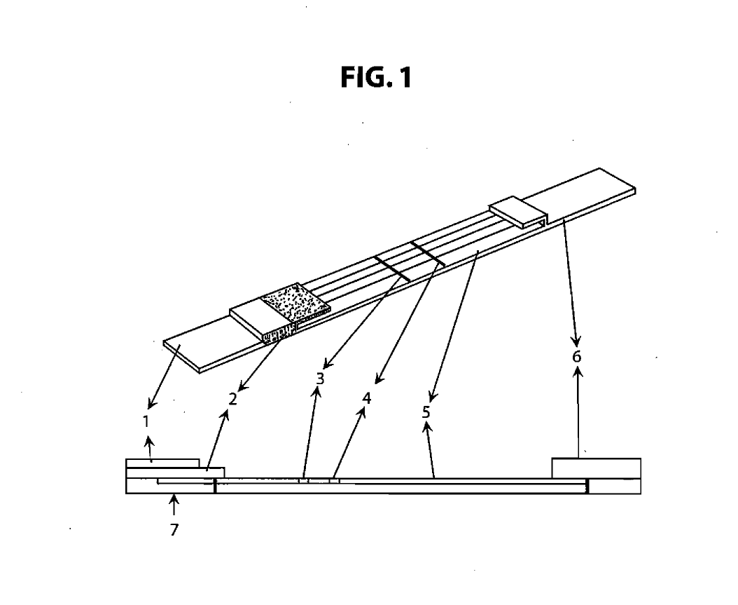

FIG. 1 shows an exploded view of a key button according to the invention.

FIG. 1 shows a view of one embodiment of a key button according to the invention. From bottom to top, the FIGURE shows a base part (1), an inscription carrier (2) and a cap part (3).

The base part (1) has an underside, an upper side, a front flank, a rear flank, a right side flank and a left side flank. In FIG. 1, the left side flank, the rear flank and the underside are not visible. The base part (1) is of elongate shape and, transversely to its longitudinal axis, is divided into a left region and a right region so that the upper side, the front flank and the rear flank are in each case divided into a left partial surface and a right partial surface. The right partial surface of the upper side and the left partial surface of the upper side form a step at their common side. The step is approximately perpendicular to the right partial surface of the upper side. The same applies in respect of the right and left partial surface of the front flank and the right and left partial surface of the rear flank. The steps in the upper side, the front flank and the rear flank form a lateral bearing surface at the right side of the left region for the cap part (3) placed onto the base part (1). The bearing surface lies in a dividing plane which divides the base part (1) into the right region and the left region. The ratio of right region to left region is approximately 2 to 1. The left partial surface of the upper side is inscribed by way of example with the letter F and the number 1. The right partial surface of the upper side has an approximately square recess (4) with a constant depth in the millimetre range. The recess (4) serves to accommodate the inscription carrier (2) and extends over almost the entire right partial surface of the upper side, so that only a narrow edge surrounds the recess (4). The width of the edge of the recess (4) is almost constant around the entire edge and is a few millimetres. The recess (4) is inscribed by way of example with an envelope symbol. An e-mail program or an e-mail function of a software application for example can be identified by this inscription when no inscription carrier (2) is placed in the recess (4). A cutout (5) is formed in the centre of the lower side of the right side flank. The cutout (5) serves to receive a fixing element of the cap part (3), such as a snap-in hook for example. Furthermore, the left-hand side of the right partial surface of the front flank has a groove (6) which runs parallel to the bearing surface. The groove (6) and a further groove (not visible in FIG. 1) arranged as a mirror image on the right partial surface of the rear flank likewise swerve to receive two further fixing elements of the cap part (3). The fixing elements of the cap part (3) are not visible in FIG. 1. On its underside, the base part (1) has on the right a plunger (7) for mounting a key button according to the invention on a key base body and on the left a web (8) for securing it against tilting of the key button in the event of considerable lateral loads during actuation of a key comprising a key button according to the invention.

The inscription carrier (2) is preferably made from paper or plastic and in the illustrated embodiment has an approximately square shape. The length, width and thickness of the inscription carrier (2) must advantageously be dimensioned in such a way that the upper side of the inscription carrier (2) placed in the recess (4) ends approximately flush with the edge of the recess (4). A magnifying glass symbol is shown by way of example on the visible side of the inscription carrier (2), which identifies for example a search function of a software application.

The cap part (3) has a shell-like configuration with an inner side and an outer side and is formed by a cap upper side, a cap front flank, a cap rear flank and a cap side flank. In FIG. 1, only the outer side of the cap upper side, the cap front flank and the cap side flank can be seen. The cap part (3) has an almost constant wall thickness. The wall thickness preferably corresponds to the height of the steps formed by the bearing surface of the base part (1) so that, when the cap part (3) is placed onto the base part (1), the left partial surface of the upper side ends approximately flush with the cap upper side, the left partial surface of the front flank ends approximately flush with the cap front flank and the left partial surface of the rear flank ends approximately flush with the cap rear flank. When the cap part (3) is placed onto the base part (1), the right partial surface of the upper side is approximately completely covered by the cap upper side, the right partial surface of the front flank is approximately completely covered by the cap front flank, the right partial surface of the rear flank is approximately completely covered by the cap rear flank and the right side flank is approximately completely covered by the cap side flank. The cap part (3) is made from a transparent material such as polymethyl acrylate for example, so that the surfaces of the base part (1) and of the inscription carrier (2) which are covered by the cap part (3) are visible through the cap part (3).

The embodiment shown in FIG. 1 of a key button according to the invention is slightly rounded in the region of the line where the left partial surface of the upper side meets the left side flank and is symmetrical with respect to its longitudinal axis, so that the embodiment of the key button according to the invention, with a suitable inscription, can be used both at a left edge and at a right edge of a keyboard.

A key button according to the invention has both an interchangeable inscription and a permanent inscription.

By means of the interchangeable inscription, an inscription of a key comprising a key button according to the invention can be adapted individually by a user. This is advantageous for example when, in a software application, the keys can be assigned a function of the software application by the user.

The permanent inscription predominantly corresponds to a predefined inscription such as, for example, a standard inscription of a function key and helps a user of a software application to find the correct key when the software application makes reference to keys using the predefined inscriptions.

The inscription of a key button according to the invention can thus be adapted individually while retaining a predefined inscription, so that a key button according to the invention helps a user to find a key both when the key is assigned a function of a software application individually by a user and when the key is assigned a function by a software application and reference is made to this key using the predefined inscription.

### LIST OF REFERENCES

1 base part
2 inscription carrier
3 cap part
4 recess for accommodating the inscription carrier (2)
5 cutout for receiving a fixing element of the cap part (3)
6 groove for receiving a fixing element of the cap part (3)
7 plunger
8 web

1. A key button comprising an inscription surface, a base part (1) and a cap part (3) which can be releasably placed onto the base part (1), characterized in that the inscription surface is divided into a first partial surface for an interchangeable inscription and a second partial surface for a permanent inscription, wherein a surface of the cap part (3) covers the first partial surface when the cap part (3) is placed onto the base part (1).

2. The key button according to claim 1, wherein the ratio of the size of the first partial surface to the size of the second partial surface is 2 to 1.

3. The key button according to any one of the preceding claims, wherein the surface of the cap part (3) which covers the first partial surface bears an inscription.

4. The key button according to any one of the preceding claims, wherein the cap part (3) is made from a transparent material.

5. The key button according to any one of the preceding claims, wherein the first partial surface has a recess (4) for accommodating an inscription carrier (2).

6. The key button according to any one of the preceding claims, characterized in that the base part (1) has an upper side, a front flank, a rear flank, a first side flank and a second side flank, wherein the upper side, the front flank and the rear flank are in each case divided into a first partial surface which adjoins the first side flank and a second partial surface which adjoins the second side flank, and in that the cap part (3) has a cap upper side, a cap front flank, a cap rear flank and a cap side flank, wherein the cap side flank approximately completely covers the first side flank, the cap upper side approximately completely covers the first partial surface of the upper side, the cap front flank approximately (completely covers the first partial surface of the front flank and the cap rear flank approximately completely covers the first partial surface of the rear flank.

7. The key button according to any one of the preceding claims, wherein the second partial surface of the upper side ends approximately flush with the cap upper side, the second partial surface of the front flank ends approximately flush with the cap front flank and the second partial surface of the rear flank ends approximately flush with the cap rear flank.

8. The key button according to any one of the preceding claims, wherein the cap part (3) can be fixed to the base part (1) by means of elastic latching elements.
